(19) United States
(12) Patent Application Publication
(10) Pub. No.: US 2020/0252322 A1
(43) Pub. Date: Aug. 6, 2020

(54) Device And Method For Managing Inter-Domain Communications Of A Network Node Assigned To The Device Within A Software-Defined Production Network System

(71) Applicant: Amine Mohamed Houyou, Jersey City, NJ (US)

(72) Inventor: Amine Mohamed Houyou, Jersey City, NJ (US)

(21) Appl. No.: 15/776,144

(22) PCT Filed: Oct. 12, 2016
(86) PCT No.: PCT/EP2016/074390

§ 371 Date: May 15, 2018

(30) Foreign Application Priority Data
Nov. 26, 2015 (DE) 102015223463.0

(51) Int. Cl. H04L 12/751; H04L 12/715; H04L 12/927; H04L 12/911; H04L 12/24

(52) U.S. Cl. CPC H04L 45/02; H04L 45/04; H04L 41/5019; H04L 47/782; H04L 47/805

(57) ABSTRACT

A device for managing inter-domain communications of a network node assigned to the device within a software-defined production network system is suggested. The software-defined production network system includes a plurality of subnets, each subnet being associated with one domain and including a plurality of network nodes. The device includes an internal communication control unit for controlling communication of the network node with a network node in the same subnet by communicating with an intra-domain control unit and includes a gateway communication control unit for controlling communication of the network node with a network node of another subnet by communicating with an inter-domain control unit adapted to control resources in the software-defined production network system.

### RELATED CASES

The present patent document is a § 371 nationalization of PCT Application Serial Number PCT/IB2016/074390, filed Oct. 12, 2016, designating the United States, and also claims the benifit of priority DE 102015223463.0, filed Nov. 26, 2015, which are hereby incorporated by reference.

### FIELD

The present embodiments relate to a device for managing inter-domain communications of a network node assigned to the device within a software-defined production network system. The present embodiments further relate to a software-defined production network system including such a device. Moreover, the present embodiments relate to a method for managing inter-domain communications of a network node assigned to the device within a software-defined production network system.

### BACKGROUND

Production systems including a plurality of production lines or buildings may be organized in so called cyber physical production systems (CPPS). Such a CPPS uses a fractal design pattern where modular fragmented components repeat the same design patterns and the same software components to support a similar behavior at each level, e.g., plug & play, self-configuration, automatic negotiation and collaboration. In such a CPPS, a cyber physical component (CPC) is the smallest computing unit and hosts a similar type of interface and supporting service as the next level of the CPPS. A cyber physical production unit (CPPU, the next larger computing unit) controls several machineries or whole lines either by combining several CPCs or coordinating a complex machine such as robot arm. The combined functionalities and services of those CPPUs that coordinate their production processes together and can closely collaborate are presented at a new level of the CPPS through a single interface by a cyber physical production center (CPPC) computing unit. The CPPS may be represented by an interface which may act as a so called MES process (manufacturing execution system) that is hosted on a server or a private cloud rather similar to a more enterprise-like representations and interfaces to the CPPCs.

In terms of communication and network infrastructure, each hosting device, i.e. CPC, CPPU or MES, has a number of networking interfaces independent of the level at which the device is hosted. In between these computing devices or hosts for applications and services, specialized networking devices such as switches and routers are also used to interconnect the whole CPPS.

In order to fully support the different behavior patterns of the different parts of the CPPS, a concept of cyber-physical networking system is defined as the possibility to request communication behavior ranging from connectivity all the way to real-time or QoS behavior on behalf of the services and applications collaborating between different hosts. This request is received through an API (application programming interface) that results in a dynamic and gradual configuration of the network. For this purpose, software-defined networking (SDN) is used as a way to turn the networking infrastructure (both in the pure networking devices and within the cyber physical computing devices), transforming the network into a programmable and manageable resource. SDN, however, assumes a flat network infrastructure accessible from a single managing or controlling node that hosts both the API used by applications and services to request networking resources and also the ability to interface, configure the programmable networking nodes and the network interfaces used by the different end-hosts.

At the same time, the fractal and modular nature of the CPPS has a consequence on the assumed flatness of the connecting network, where some element of hierarchy is needed. The fractal nature of the CPPS does not exclude interactions and communication between the smallest device to the highest organizational computing element in the CPPS. For example, a sensing device part of a cyber physical production unit can, besides delivering sensing values for the machine itself, also provide some data directly to some MES system in the highest level of the factory.

Communication services or programmable network slices (i.e. a virtual network) can be requested across different zones. A slice in this context is a logical partition of a physical (automation) network system. Thus, a slice is a virtual network or subnet of the whole network. The exchange of data no longer relies on heavily pre-engineered/pre-configured application layer gateways, which dispatch data from isolated network isles to the outside server infrastructure. Instead, applications and services hosted in any production sub-system or device interact in a dedicated network slice (e.g. a virtual network deployed across different physical subsystems).

The current organization of the slice system requires one SDN controller interacting with several networked devices that all host an SDN client or software agent. In the case of automation systems, the SDN controller is called a slice manager and the software agent is called a slice enforcement point (SEP). The SEP runs on any device that has one or several network interfaces, which includes all the cyber physical devices where application logic is hosted and the networking devices such as switches and routers. Each node is represented in the slice system through a SEP.

The role of an SEP is to (i) announce that a given device is now connected to the network and registers the node's ID, number and ID of network interfaces, as well as other attributes such as networking capabilities and offered QoS features; (ii) the SEP also acts as a software agent that translates the slice-related commands enforcement details sent by the slice manager to a local implementation or definition of the specific command (e.g. add node X to slice Y with QoS features Z should be mapped to a specific OS command under Linux to create a container for a specific App, and attach this container to a virtual network interface, which is shaped using a traffic shaping method under Linux and tagging frames with a VLAN number associated with a specific slice ID).

The slice manager can then act on the offered programmable networking features by sending specific commands through a south bound API. A typical work flow includes:

1. Register device, announcing networking capabilities, networking features, or number of interfaces, topology relations, etc.

2. Obtain a unique identifier from the slice manager to each SEP that represents the ID of each node in a virtual model of the network.

3. After receiving a slice request negotiated between CPP—Devices using a plug procedure through the slice manager's API, the slice manager can define the logical layout of a slice and the way to enforce this in the provided node.

The slice manager assumes a flat network structure, which can encompass several tens or hundreds of nodes. The reason to segment the network may be to allow some load balancing, which limits the maximum load in terms of managed SEPs managed by a slice manager (SM).

However, some networks are not segmented only in a horizontal way, i.e. slitting a large network of SEPs between two or more slice managers, but are also segmented due to the fractal nature of the cyber-physical system where a network of SEPs first exists within the borders of a CPPU before joining a larger CPPS where several other CPPUs are already managed by a single slice manager.

In a software-defined production network, several subnets, i.e. virtual networks within a large network, might exist due to organizational needs or to simply geographic reasons. For example, some production sites may be structured into specialized production halls, e.g. body shop lines, press stamping lines, paint shop lines and final assembly. Other related sites such as production logistics and part supplies might be located in different buildings. The whole plant may be considered as forming a cyber-physical production plant where communication infrastructure is segmented according to the buildings or the production function located in each production hall.

### SUMMARY AND DETAILED DESCRIPTION

It is one object to provide an improved way of communication within a software-defined production network system being segmented not only horizontally but also vertically.

Thus, a device for managing inter-domain communications of a network node assigned to the device within a software-defined production network system is provided. The software-defined production network system includes a plurality of subnets, each subnet being associated with one domain and including a plurality of network nodes. The device includes an internal communication control unit for controlling communication of the network node with a network node in the same subnet by communicating with an intra-domain control unit assigned to the subnet and includes a gateway communication control unit for controlling communication of the network node with a network node of another subnet by communicating with an inter-domain control unit adapted to control resources in the software-defined production network system.

The network node may be for example a single device or a higher-level device including a plurality of single, lower-level devices, but may also be a router or switch or the like. The device may manage the network node by using a virtual model of the network node including, for example, a representation of the higher-level device (e.g., the complete machine or production line with the production system) and the lower-level devices (e.g., actuators or sensors) and the topology of the communication network between these devices. The unifying digital model of each node in the network recreates a virtual node whose interfaces represent the physical network interfaces of the real node which are active (i.e., connected to the rest of the network) combined with a description of their offered type of service (e.g. hard real-time guaranteed service, bandwidth reservation, jitter guarantees, etc.).

The internal communication control unit represents an internal SEP (slice enforcement point) and the gateway communication control unit represents an external or gateway SEP. Such control units may be assigned to all or some network nodes within a subnet. Using the two kinds of communication control units, communication traffic across multiple domains or multiple levels (i.e., horizontally and vertically) may be managed. The internal SEP may represent the single device (e.g., actuator/sensor devices or local control unit) as single networked device (i.e., as the lower-level devices of the network node), while the external or gateway SEP may represent the whole machine or line as a single network node in the complete network of machines.

When the device is used as a slice manager, the internal SEP manages the lower level networked devices, while aggregates such as modules, lines or whole workspaces may be managed by the external SEP coordinating connectivity and communication services crossing single domain boundaries.

By using the gateway SEP, the hosting network node may be part of two slice domains (i.e., of two subnets). The gateway SEPs are connected on a higher level than the subnets itself (i.e., are connected in a supernet level, which is a higher hierarchy level than a subnet).

The respective entity (e.g., the internal communication control unit) may be implemented in hardware and/or in software. If said entity is implemented in hardware, the entity may be embodied as a device (e.g., as a computer or as a processor or as a part of a system, such as a computer system). If said entity is implemented in software, the entity may be embodied as a computer program product, as a function, as a routine, as a program code or as an executable object, which may be executed by a hardware computer.

According to an embodiment, the internal communication control unit and the gateway communication control unit are adapted to control communications based on quality of service (QoS) requirements of the network node.

The internal communication control unit and the gateway communication control unit may interact to provide the best path within the whole network in order to provide specific QoS requirements. This means that for example, although only an internally communication is requested, the internal communication control unit and the gateway communication control unit may provide a path outside the subnet in order to satisfy the QoS requirements of the current communication.

According to a further embodiment, the gateway communication control unit is connected to a gateway communication control unit of at least one other subnet.

Each subnet includes at least one slice manager or intra-domain control unit. The device is connected to the slice manager of the same subnet and is connected to one or more gateway control units of network nodes in other subnets. A communication between the different subnets may be organized by the intra-domain control units communicating with the inter-domain control unit, and the communication may be carried out via the gateway communication control units.

According to a further embodiment, the device further includes a transformation unit for transforming a communication language used by the internal communication control unit into a communication language used by the gateway communication control unit and vice versa.

This embodiment provides the advantage that different communication languages may be used by the internal lower-level devices and the higher-level devices. A translation between the different communication languages may be carried out by the internal communication control unit and the gateway communication control unit. Thus, internally and externally, different communication languages may be used. Internally means that a communication is performed within the network node and its subnodes (i.e., lower-level devices). Externally means that a communication is performed between the network node and other network nodes. In other words, internal communication is a communication in a lower hierarchy level than external communication.

According to a further embodiment, the internal communication control unit is adapted to register the network node with the intra-domain control unit of the subnet.

The intra-domain control unit of the subnet may be an internal slice manager. Registered means that the network node is now known to the slice manager using an ID.

According to a further embodiment, the gateway communication control unit is adapted to communicate with the inter-domain control unit for receiving information with respect to a path between the subnets from the network node to a network node within another subnet.

The inter-domain control unit may be an inter-domain slice manager. The inter-domain slice manager is adapted to organize communications between the plurality of subnets.

According to a further embodiment, the gateway communication control unit is adapted to register the network node with the inter-domain control unit.

The network node may be registered with the same ID as with the internal slice manager. The inter-domain control unit may know the external Interface and the neighboring gateway communication control units of the network node.

According to a further embodiment, the gateway communication control unit is adapted to provide the inter-domain control unit with information of connected gateway communication control units of other subnets.

Thus, the inter-domain control unit may get an overall image of the whole network by receiving this information from all gateway communication control units within the network. Based on this information, the inter-domain control unit may manage communications between the different subnets.

By controlling the resources allocated in the network connecting the gateway communication control units (also called gateway SEP agents) and by accessing a database of the intra-domain control unit (also called local slice manager) including the device IDs within the network, an end-to-end connection between two devices in two different subnets may be mediated. The inter-domain slice manager may also trigger both local slice managers to allocate the appropriate resources for the communication paths in their respective domains, between the end-CPCs (i.e. network nodes behind the network node including a gateway communication control unit) and the gateway device (i.e. the network node including a gateway communication control unit).

Connecting to a remote device attached to a different subnetwork may thus take the following steps:

1) Request a slice between end-CPC IDs with all the required qualities, this is sent to the local slice manager.
2) The local slice manager contacts the inter-domain slice manager to mediate the ID of the goal CPC.
3) The inter-domain slice manager queries the other slice managers and finds out where the CPC is located.
4) The remote device asks both local slice managers if the resources and paths exist between the CPCs and their respective gateway SEPs.
5) The inter-domain slice manager decides on how to construct the slice mapping between the gateway SEPs.
6) The remote device finally triggers the local slice managers and constructs the slice between the CPCs and their gateway SEPs, and also the controlled routers and switches connecting the gateway SEPs to deploy the network slice between the gateway SEPs.
7) The end-to-end slice or path between the remote CPCs is now ready for use.

Any embodiment of the first aspect may be combined with any embodiment of the first aspect to obtain another embodiment of the first aspect.

According to a further aspect, a software-defined production network system is provided. The software-defined production network system comprises a plurality of subnets, each subnet being associated with one domain and including an intra-domain control unit and a plurality of network nodes, each network node comprising a device as described above, and an inter-domain control unit for managing communication between the plurality of subnets by communicating with the devices.

According to an embodiment, the inter-domain control unit is adapted to communicate with the gateway communication control units of the devices.

Thus, the inter-domain control unit is a slice manager outside all subnets but may communicate with each subnet via the gateway communication control units.

According to a further embodiment, the inter-domain control unit is adapted to receive information with respect to resources and/or network topology of each network node.

The inter-domain control unit has an overall knowledge of the network topology and can thus manage communications within the whole network.

According to a further aspect, a method for managing inter-domain communications of a network node assigned to the device within a software-defined production network system is provided. The software-defined production network system includes a plurality of subnets, each subnet being associated with one domain and including a plurality of network nodes. The method includes the following acts: controlling internal communication of the network node with a network node in the same subnet by communicating with an intra-domain control unit assigned to the same subnet, and controlling external communication of the network node with a network node of another subnet by communicating with an inter-domain control unit adapted to control resources in the software-defined production network system.

The embodiments and features described with reference to the device and system of the present embodiments apply mutatis mutandis to the method of the present embodiment.

According to a further aspect, one embodiment relates to a computer program product have program code for executing the above-described method for managing inter-domain communications of a network node assigned to the device within a software-defined production network system when run on at least one computer.

A computer program product, such as a computer program on a storage medium, may be embodied as a memory card, USB stick, CD-ROM, DVD or as a file in another memory that may be downloaded from a server in a network. For example, such a file may be provided by transferring the file as the computer program product from a wireless communication network.

Further possible implementations or alternative solutions also encompass combinations—that are not explicitly mentioned herein—of features described above or below with regard to the embodiments. The person skilled in the art may also add individual or isolated aspects and features to the most basic form of the invention. The scope of the present invention is defined solely by the appended claims and is not affected to any degree by the statements within this summary.

### BRIEF DESCRIPTION OF THE DRAWINGS

Further embodiments, features and advantages will become apparent from the subsequent description and dependent claims, taken in conjunction with the accompanying drawings, in which:

FIG. 1 shows a schematic block diagram of an embodiment of a device for managing inter-domain communications of a network node;

FIG. 2 shows a schematic overview of an example software-defined production network system including the device of FIG. 1; and

FIG. 3 shows a sequence of one embodiment of method acts of a method for managing inter-domain communications of a network node.

In the Figures, like reference numerals designate like or functionally equivalent elements, unless otherwise indicated.

### DETAILED DESCRIPTION

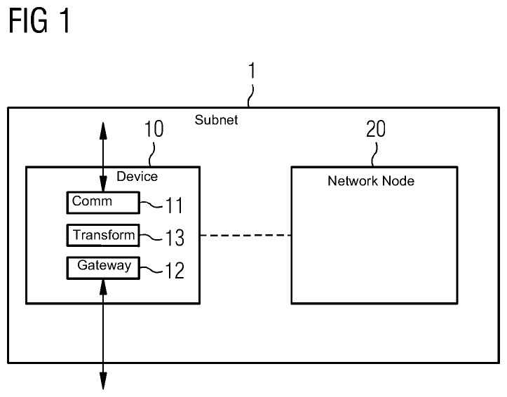

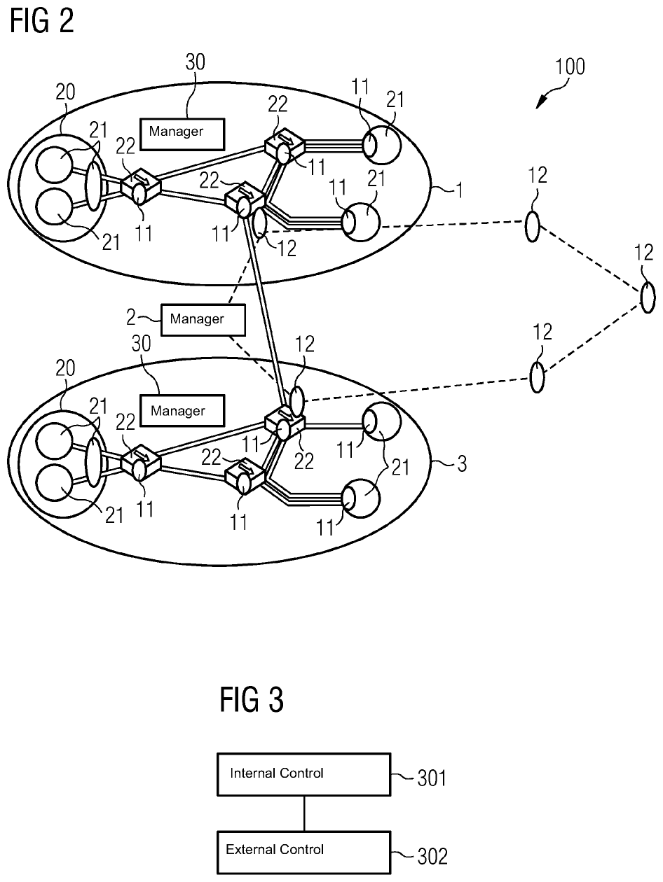

FIG. 1 shows a subnet 1 of a software-defined production network system 100, which will be described later with reference to FIG. 2.

The subnet 1 includes at least one network node 20 which may be a router or switch 22 (shown in FIG. 2) or a lower-level device 21 or a higher-level device including a plurality of lower-level devices 21. The network node 20 is assigned to a device 10 for managing inter-domain communications of the network node 20. The device 10 may be integrated into the network node 20.

The device 10 includes an internal communication control unit or controller 11 for controlling communication of the network node 20 with another network node 20 in the same subnet 1.

The device 10 further includes a gateway communication control unit or controller 12 for controlling communication of the network node 20 with a network node 20 of another subnet 1.

In addition, the device 10 includes a transformation unit or controller 13 for transforming a communication language used by the internal communication control unit 11 into a communication language used by the gateway communication control unit 12 and vice versa.

The internal communication control unit 11 and the gateway communication control unit 12 may be called internal SEP agent and external SEP agent, respectively.

Such a network node 20 or device 10 running both an internal SEP agent 11 and an external SEP agent 12 has to be physically connected to two domains (i.e., to two subnets 1), as shown in FIG. 2.

In FIG. 2, two subnets 1, 3 are shown as an example. The other subnets within the network system 100 are only represented via the gateway communication control units 12. The structure of the subnets 1, 3 is identical. Each includes one network node 20 including a device 10 illustrated by an internal communication control unit 11 and a gateway communication control unit 12. Further, the subnets 1, 3 include a plurality of network nodes 20, for example lower-level devices 21 which have only an internal communication control unit 11 or higher-level devices including a plurality of lower-level devices 21. As can be seen, the network nodes 21 and 20 within the subnets 1, 3 communicate via their internal communication control units 11. For the communication within one subnet 1, 3, an internal control unit or slice manager (controller) 30 is provided.

If one network node 20, 21 wants or needs to communicate with a network node 20, 21 of another subnet 1, 3, this communication is carried out via one or more network nodes 20 including an internal communication control unit 11 and a gateway communication control unit 12. In the example of FIG. 2, the network node 20 being able to control communication outside the subnet 1, 3 is a router or switch 22.

The gateway communication control unit 12 communicates with an inter-domain control unit 2 or inter-domain slice manager (controller) 2.

The inter-domain slice manager 2 may query the registries of each local (or internal) slice manager 30 when receiving a slice request to communicate between a network node 20, 21 in subnet 1 to a network node 20, 21 in subnet 3. Once the node ID is located and its coordinating internal slice manager 30 as well, the slice request may be forwarded to the internal slice manager 30 only mentioning the gateway SEP 12 and the internal node ID plus the type of resources requested in between the two. The route and resources allocated between two gateway SEPs 12 are managed and configured by the inter-domain slice manager 2.

If a CPPU hosting a slice manager 30 and several SEPs 20 interconnected to a CPPC, depending on the network size, the SEPs 20 may simply merge with the CPPU's slice manager, or may keep their internal slice manager 30, while selecting one node 20 to act as a gateway SEP, and the local slice manager 30 registers with the CPPC's slice manager which is then considered as level one intra-domain slice manager 2. Thus, the structure may be extended vertically as well as horizontally.

FIG. 3 shows a method for managing inter-domain communications of a network node 20 as carried out by the device 10 of FIG. 1.

In a first act 301, internal communication of the network node 20 with a network node 20 in the same subnet 1, 3 are controlled by communicating with an intra-domain control unit 30 assigned to the same subnet 1, 3.

In a second act 302, external communication of the network node 20 with a network node 20 of another subnet 1, 3 is controlled by communicating with an inter-domain control unit 2 adapted to control resources in the software-defined production network system 100.

Although the present invention has been described in accordance with preferred embodiments, it is obvious for the person skilled in the art that modifications are possible in all embodiments.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A device for managing inter-domain communications of a network node assigned to the device within a software-defined production network system, the software-defined production network system including a plurality of subnets, each subnet being associated with one domain and including a plurality of network nodes, the device comprising:
an internal communication controller for controlling communication of a first one of the network nodes with a second one of the network nodes in a first subnet of the subnets by communicating with an intra-domain controller assigned to the first subnet, and
a gateway communication controller for controlling communication of the first network node with a third one of the network nodes of a second subnet of the subnets by communicating with an inter-domain controller configured to control resources in the software-defined production network system,
wherein the internal communication controller and the gateway communication controller are configured to control the communications based on quality of service requirements of the first network node and are adapted to interact to provide a path within the software-defined production network system in order to provide the quality of service requirements of the first network node.

2. The device according to claim 1, wherein the gateway communication controller is connected to a gateway communication controller of the second subnet.

3. The device according to claim 1, further comprising a transformation unit for transforming a communication language used by the internal communication controller into a communication language used by the gateway communication controller and vice versa.

4. The device according to claim 1, wherein the internal communication controller is configured to register the first network node with the intra-domain controller of the first subnet.

5. The device according to claim 1, wherein the gateway communication controlleris configured to communicate with the inter-domain controller for receiving information with respect to a path between the first and second subnets from the first network node to the third or a fourth network node within the second subnet.

6. The device according to claim 5, wherein the gateway communication controller is configured to register the first network node with the inter-domain controller.

7. The device according to claim 6, wherein the gateway communication controller is configured to provide the inter-domain controller with information of other connected gateway communication controllers of the second or a third subnet.

8-10. (canceled)

11. A method for managing inter-domain communications within a software-defined production network system, the software-defined production network system including first and second subnets, each of the first and second subnets being associated with one domain and including a plurality of network nodes, the method comprising:
controlling, in a first subnet internal communication of a first network node with a second network node by communicating with an intra-domain control unit assigned to the first subnet, and
controlling external communication of the first network node with a third network node of the second subnet by communicating with an inter-domain control unit adapted to control resources in the software-defined production network system,
wherein communications are controlled based on quality of service requirements of the first network node and are controlled using the internal communication and the external communication to provide a path within the software-defined production network system in order to provide the quality of service requirements of the first network node.

12. (canceled)

13. The device according to claim 2, further comprising a transformation unit for transforming a communication language used by the internal communication controller into a communication language used by the gateway communication controller and vice versa.

14. The device according to claim 13, wherein the internal communication controller is configured to register the first network node with the intra-domain controller of the first subnet.

15. The device according to claim 14, wherein the gateway communication controller.is configured to communicate with the inter-domain controller for receiving information with respect to a path between the first and second subnets from the first network node to the third or a fourth network node within the second subnet.

16. A software-defined production network system comprising:
a plurality of subnets, each subnet being associated with one domain and including an intra-domain controller and a plurality of network nodes, each network node comprising a device, and
an inter-domain controller for managing communication between the plurality of subnets by communicating with the devices,
wherein each device comprises (1) an internal communication controller for controlling communication of a first one of the network nodes in a first subnet of the subnets with a second one of the network nodes in the first subnet of by communicating with an intra-domain controller assigned to the first subnet, and (2) a gateway communication controller for controlling communication of the first network node with a third one of the network nodes of a second subnet of the subnets by communicating with the inter-domain controller, which is configured to control resources in the software-defined production network system, wherein the internal communication controller and the gateway communication controller are configured to control the communications based on quality of service requirements of the first network node and are adapted to interact to provide a path within the software-defined production network system in order to provide the quality of service requirements of the first network node.

17. The software-defined production network system according to claim 16, wherein the inter-domain controller is configured to communicate with the gateway communication controllers of other ones of the devices.

18. The software-defined production network system according to claim 17, wherein the inter-domain controller is configured to receive information with respect to resources and/or network topology of each of the network nodes.
